(19) United States
(12) Patent Application Publication
(10) Pub. No.: US 2018/0135666 A1
(43) Pub. Date: May 17, 2018

(54) TWIN-FIN FAIRING

(71) Applicant: LANKHORST ENGINEERED PRODUCTS B.V.

(72) Inventors: ARNOLDUS VAN BELKOM, SPANNUM (NL); KARST MEIJER, LEEUWARDEN (NL)

(21) Appl. No.: 15/526,397

(22) PCT Filed: Nov. 17, 2015
(86) PCT No.: PCT/NL2015/050803

§ 371 Date: May 12, 2017

(30) Foreign Application Priority Data
Nov. 19, 2014 (NL) 2013829

(51) Int. Cl. F15D 1/10; E21B 17/01; B63B 21/66; B63B 21/50

(52) U.S. Cl. CPC F15D 1/10; E21B 17/01; B63B 2021/504; B63B 21/502; B63B 21/663

(57) ABSTRACT

A fairing (1) for improving fluid flow around a circular-cylindrical object comprises a first fairing-element (11) and a second fairing-element (12), which are releasable relative to one another. The fairing-elements are easy to manufacture, compactly stackable, and easy to install around the object. In installed condition, the first fairing-element and the second fairing-element are mutually connected in circumferential direction of the fairing, while forming a twin-fin fairing, which reduces vortex-induced vibrations around the object, while providing favourable flow resistance, and without performing galloping motions.

The invention relates to a twin-fin fairing for improving fluid flow around a circular-cylindrical object.

In the present document, a “fairing” refers to a device for improving fluid flow around a circular-cylindrical object, wherein the device has an operation condition in which the device is installed around said circular-cylindrical object and, under influence of said fluid flow, is reciprocally rotatable relative to the object about the longitudinal direction of the object.

Furthermore, for descriptive purposes, a “circumferential direction” and a “longitudinal direction” of the fairing in the present document are defined as corresponding to the circumferential direction and the longitudinal direction, respectively, of the circular-cylindrical object in said operation condition of the fairing.

In the present document, by the term “twin-fin” in the expression “twin-fin fairing” it is meant that the fairing has two fins in the sense that in said operation condition the fairing over at least one first subrange of its overall-range in its longitudinal direction, and as seen in perpendicular cross-section to its longitudinal direction, comprises at least one U-shaped portion, which according to the curvature of its U-shape envelopes the object in the circumferential direction of the fairing, and wherein the fairing comprises a first fin and a second fin, which are formed by the at least one U-shaped portion, and which are protruding in a free-ending manner—in the sense of the two free-ending legs of said U-shape, respectively—relative to the object, and which make the fairing rotate according to said reciprocal rotatability under influence of said fluid flow.

WO2008/021674A2 (hereinafter WO'674) describes that the more traditional “teardrop” fairings are indeed effective in reducing, with low flow resistance, vortex-induced vibrations about a circular-cylindrical object placed in a fluid flow, however, it also describes that these teardrop fairings are susceptible to undesirable “galloping motions”, see paragraph [0009] of WO'674. Furthermore, WO'674 describes that by the application of twin-fin fairings, instead of teardrop fairings, said galloping motions of the fairings can be eliminated, while maintaining the reduction of vortex-induced vibrations, obtained with low flow resistance.

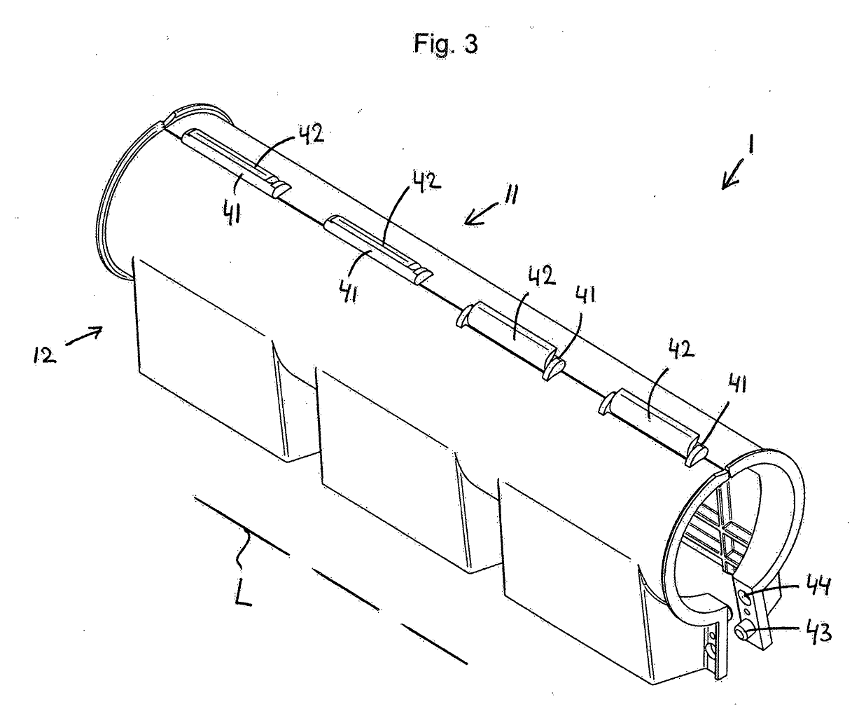

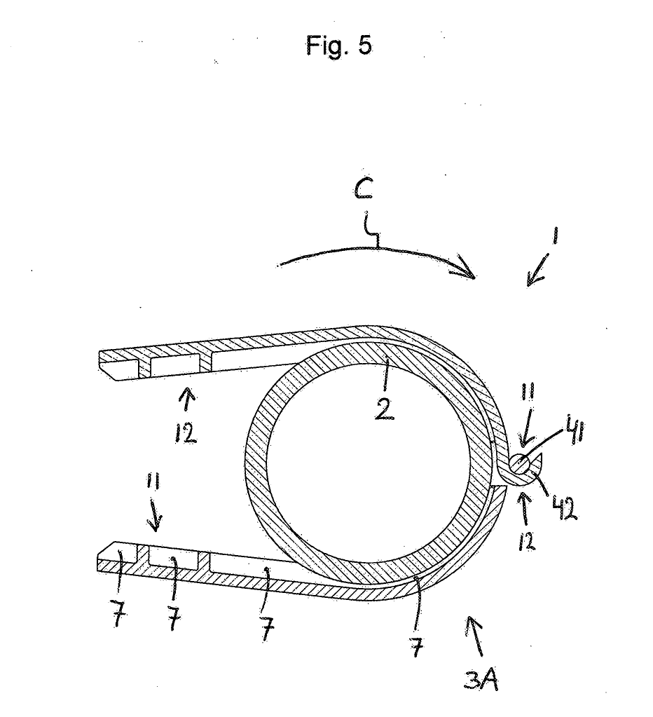

One twin-fin fairing 16 known from WO'674 (see FIG. 5A of WO'674) has a U-shaped shell 20 (separately shown in FIG. 3 of WO'674), to which a plurality of “bearing pads” 32 (separately shown in FIG. 7 of WO'674) are fixedly attached.

Another twin-fin fairing 16A known from WO'674 (see FIGS. 9-14 of WO'674) has a shell 20N with two fins 22N. With the help of V-shaped recesses 70 in flanges 24 (see FIG. 13 of WO'674), the fins 22N are hingeable in order to be able to install the shell 20N around a cylindrical object. Furthermore, the fins 22N are provided with multiple pairs of connectors 78a and 78B, via which the fins 22N can be fixedly attached to one another in order to install the twin-fin fairing 16A around the cylindrical object.

The twin-fin fairings known from WO'674 have a number of drawbacks, which have to do with the circumstances that they are usually applied in large numbers at a certain location, and that said location of application usually is an off-shore location. Namely, both the manufacturing and the installing of the known fairings is laborious. Especially when it concerns large numbers, this is very disadvantageous. In the said circumstances it is furthermore disadvantageous that these known elements are voluminous and therefore take much storage space during transport to the off-shore location and at said off-shore location. Thereby, not only said transport becomes expensive, but also at the off-shore location there usually is not enough space available for many voluminous elements.

It is an object of the invention to provide elements for reducing vortex-induced vibrations around a circular-cylindrical object, which is placed in a fluid flow, wherein the elements have low flow resistance, and wherein the abovementioned galloping motions of the elements are prevented, and wherein the elements can be easily manufactured and installed, while large numbers of the elements occupy little space.

For that purpose the invention provides a twin-fin fairing according to appended independent claim 1. Specific embodiments of the invention are set forth in the appended dependent claims 2-8.

Hence, the invention provides a twin-fin fairing for improving fluid flow around a circular-cylindrical object, wherein the fairing has an operation condition in which:

the fairing is installed around said circular-cylindrical object and, under influence of said fluid flow, is reciprocally rotatable relative to the object about the longitudinal direction of the object,

the circumferential direction and the longitudinal direction of the circular-cylindrical object are defining a corresponding circumferential direction of the fairing and a corresponding longitudinal direction of the fairing, respectively, and

the fairing comprises, along at least one subrange of its overall-range in its longitudinal direction, and as seen in perpendicular cross-section relative to its longitudinal direction, at least one U-shaped portion, respectively, which according to the curvature of its U-shape envelopes the object in the circumferential direction of the fairing, and wherein the fairing comprises a first fin and a second fin, which are formed by the at least one U-shaped portion, and which are protruding in a free-ending manner relative to the object, according to the two free-ending legs, respectively, of said U-shape, and which make the fairing rotate according to said reciprocal rotatability under influence of said fluid flow;

characterized in that the fairing comprises a first fairing-element and a second fairing-element, which are releasable relative to one another, and wherein said operation condition of the fairing requires an assembled condition of the first fairing-element and the second fairing-element, in which assembled condition the first fairing-element and the second fairing-element are mutually connected in the circumferential direction of the fairing, and wherein the first fairing-element and the second fairing-element are comprising the first fin and the second fin, respectively.

Hence, the fairing according to the invention is modular in the sense that the fairing is divided in the first fairing-element and the second fairing-element, which can be mutually connected in the circumferential direction of the fairing. Thanks to this modularity, said elements can be manufactured separate from one another as a kind of shell-parts. Because of this, each element can be manufactured easily and with low costs, for example with a suitable mould in an injection moulding process. Furthermore, thanks to the shell-part-like shapes of the elements, they are compactly stackable. Because of this, they occupy little space during their transport to the installation site (usually an off-shore location), as well as at the installation site. Furthermore, the two shell-part-like elements can be mounted from two opposed sides against the cylindrical object, to be enveloped, which simplifies the installing. Since in its assembled operation condition the fairing is forming a twin-fin fairing around the object, the fairing is effective in reducing vortex-induced vibrations, without accompanying high flow resistance and without accompanying galloping motions of the fairing.

In a preferable embodiment of a twin-fin fairing according to the invention, as seen in said operation condition, the fairing comprises along at least one second subrange of its overall-range in its longitudinal direction, and as seen in perpendicular cross-section relative to its longitudinal direction, at least one O-shaped portion, respectively, which according to the curvature of its O-shape envelopes the object in the circumferential direction of the fairing. Said O-shape in the at least one second subrange provides a reliable and firm envelope with a view to the reciprocal rotatability of the fairing relative to the object, under influence of fluid flows around the object.

In principle, the first fin and the second fin of a fairing according to the invention can also be present in the at least one second subrange.

Preferably, however, the first fin and the second fin are absent in the at least one second subrange. The reason is that this absence promotes the compact stackability of the first fairing-elements and/or the second fairing-elements when applying said O-shape in the at least one second subrange. That is, it then becomes possible to mutually nest the first and/or the second fairing-elements also with their in-part O-shapes, in other words that C-like shaped parts of said O-shapes are being mutually nested, without legs of U-shapes being in the way.

In principle, the first fairing-element and the second fairing-element of a fairing according to the invention can be differently shaped elements, in which case they can for example be mutual mirror images, and can for example also be assembled in a mutually mirrorwise orientation.

In a further preferable embodiment of a twin-fin fairing according to the invention, the first fairing-element and the second fairing-element (12) are mutually identical. In general, this reduces the manufacturing costs of the fairing-elements. For example, in case of manufacturing by means of a mould, only one mould shape is required. The application of identical elements also is advantageous in many logistic respects, since in production, transport, storage, installation, etc., of the elements one never has to take into consideration the (proportional) availability of different elements. After all, distinction between different elements is never needed then.

In a further preferable embodiment of the lastmentioned preferable embodiment of a twin-fin fairing according to the invention, as seen in said assembled condition, the fairing is rotational symmetrical in the sense of a 180 degrees rotation of the complete fairing about a mathematical rotation axis which is perpendicular to said longitudinal direction of the fairing. Said rotational symmetry means that each arbitrary one of the two fairing-elements of the fairing after performing said 180 degrees rotation occupies the space, which was occupied by the other one of the two fairing-elements of the fairing prior to performing said 180 degrees rotation. Said rotational symmetry offers, in spite of the identical character of the two fairing-elements, sophisticated possibilities for obtaining effective interconnections of the two elements in the circumferential direction of the fairing.

In a further preferable embodiment of the lastmentioned preferable embodiment of a twin-fin fairing according to the invention, the first fairing-element comprises a first interlocking structure integrally manufactured therewith, which, for forming said assembled condition, can interlock, in a manner determined by said being rotational symmetrical, with a second interlocking structure of the second fairing-element, which second interlocking structure is identical to the first interlocking structure because the second fairing-element is identical to the first fairing-element. Such interlocking structures are an example that, in spite of the identical character of the two fairing-elements, sophisticated possibilities do exist for obtaining non-mirrorwise, reliable interconnections (in this case interlockings) of the two elements in the circumferential direction of the fairing.

In a further preferable embodiment of the lastmentioned preferable embodiment of a twin-fin fairing according to the invention, the first interlocking structure comprises at least one first interlocking pin and at least one first interlocking edge, which at least one first interlocking pin and at least one first interlocking edge are identical to at least one second interlocking pin and at least one second interlocking edge of the second interlocking structure, respectively, and wherein, as seen in said assembled condition:

the at least one first interlocking edge catches in a hingeable manner around the at least one second interlocking pin, respectively,

the at least one second interlocking edge catches in a hingeable manner around the at least one first interlocking pin, respectively, and

the at least one first interlocking pin and the at least one second interlocking pin are mutually in-line according to a hinge line, which corresponds to said hingeable manners, which hinge line is parallel to the longitudinal direction of the fairing, and which hinge line is extending in said operation condition at a side of the fairing facing away from the free ends of the first fin and the second fin, and about which hinge line the first fairing-element and the second fairing-element are hingeable relative to one another.

Such mutual hingeability of the first fairing-element and the second fairing-element simplifies the installation of the fairing. For example, the two fairing-elements can, prior to the installation around an object, be already in a mutual catching engagement in a yet somewhat open hinge position in which the two fins have not yet been brought as close together as in the operation condition. Also it is possible to compactly stack a plurality of pairs of such fairing-elements, when they are in somewhat open hinge positions.

In a further preferable embodiment of a twin-fin fairing according to the invention, the first fairing-element is made of plastic and/or the second fairing-element is made of plastic. Because of this each element can be manufactured easily and with low costs, for example with a suitable mould in an injection moulding process. A suitable plastic is for example a foamed plastic, and more in particular a polyethene (PE). Because of this, the element not only is lightweight, but it can also be manufactured from recycled plastic, which is environment-friendly. Another suitable material is for example a polypropylene (PP). Such a material has good shape-retaining properties, also at high temperatures, and can for example be applied to pipings through which a fluid is transported under increased temperature.

In the following, the invention is further elucidated with reference to some non-limiting embodiments and with reference to the schematic figures in the attached drawing.

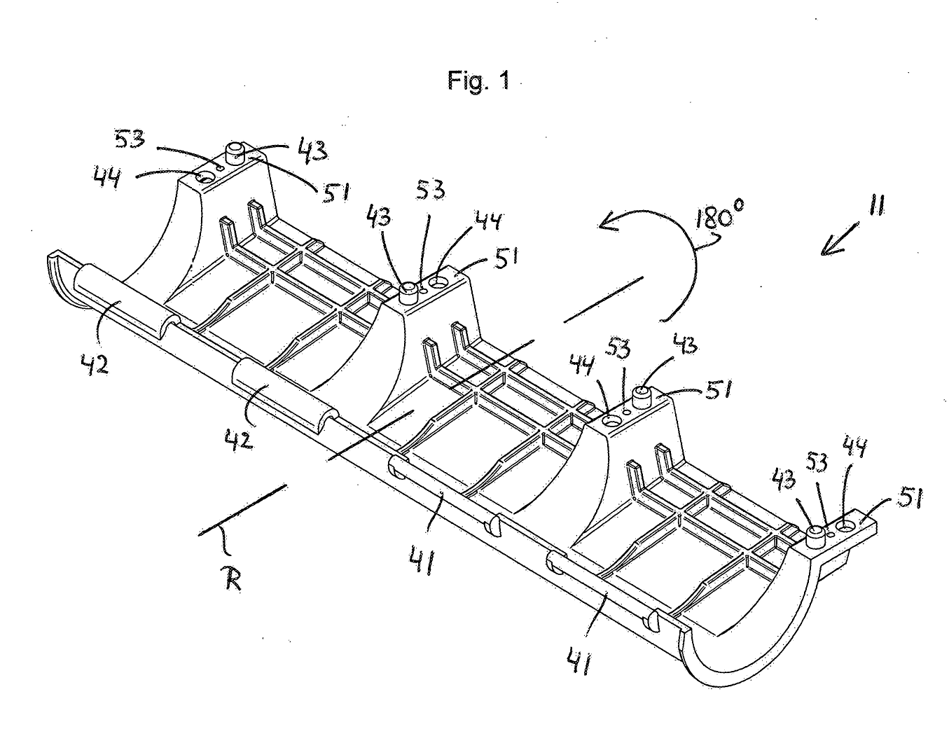

FIG. 1 shows, in perspective view, an example of an embodiment of a first fairing-element of a twin-fin fairing according to the invention.

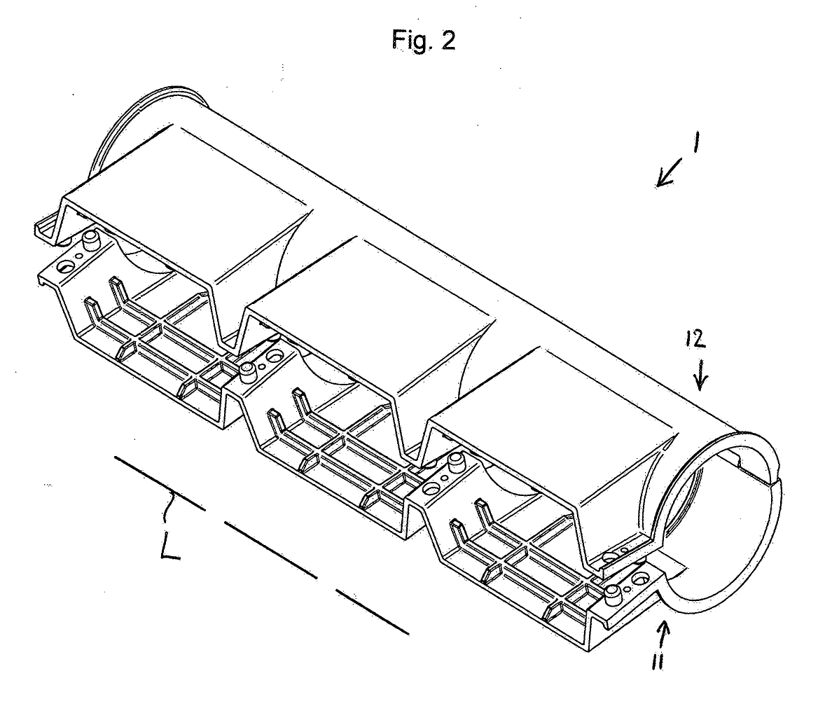

FIG. 2 shows, in perspective view, an example of an embodiment of a twin-fin fairing according to the invention, which twin-fin fairing comprises the first fairing-element of FIG. 1, and wherein the second fairing-element of the shown twin-fin fairing is identical to the first fairing-element, and wherein the first interlocking structure of the first fairing-element has been brought in partial interlocking with the second interlocking structure of the second fairing-element.

FIG. 3 shows the situation of FIG. 2 in another perspective view.

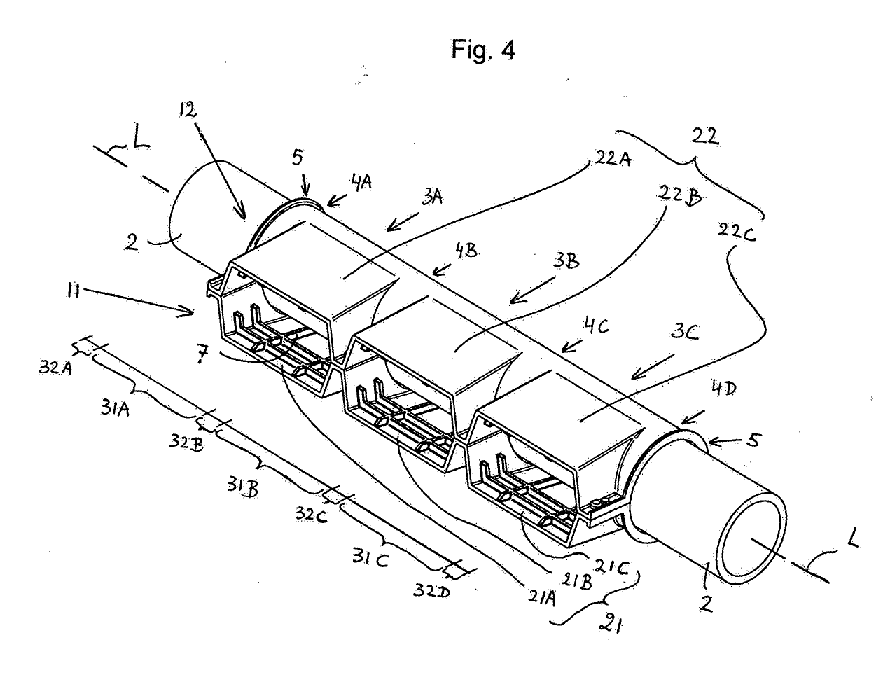

FIG. 4 shows the twin-fin fairing of FIG. 2 again in perspective view, however, wherein this time the first interlocking structure and the second interlocking structure have been brought in full interlocking, whereby the assembled condition of the fairing is formed, and, more specifically, wherein the operation condition of the fairing is formed in which the fairing is installed around a circular-cylindrical object.

FIG. 5 shows the situation of FIG. 4 in a cross-section, which is taken within said at least one first subrange perpendicularly to the longitudinal direction of the fairing, and in which cross-section there is occurring said U-shape of said U-shaped portion of the fairing.

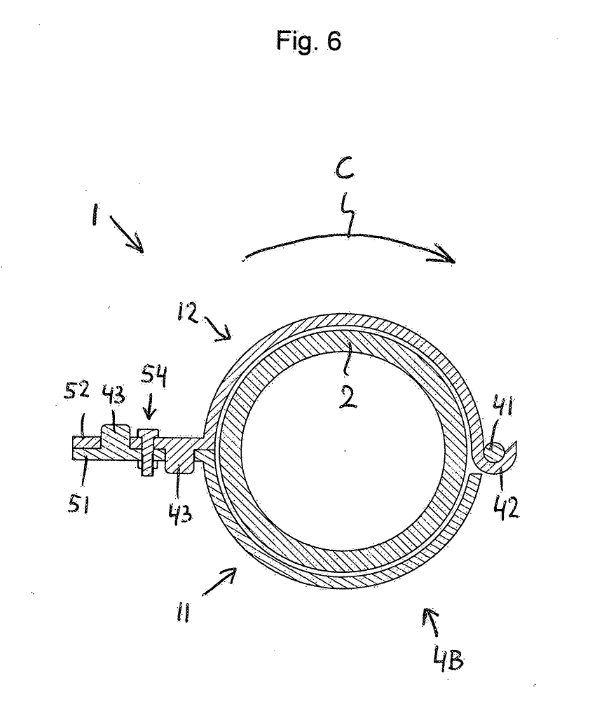

FIG. 6 shows the situation of FIG. 4 in a cross-section, which is taken within said at least one second subrange perpendicularly to the longitudinal direction of the fairing, and in which cross-section there is occurring said O-shape of said O-shaped portion of the fairing.

FIG. 7 shows, in perspective view, two specimens of the first fairing-element of FIG. 1 in a compactly stacked condition.

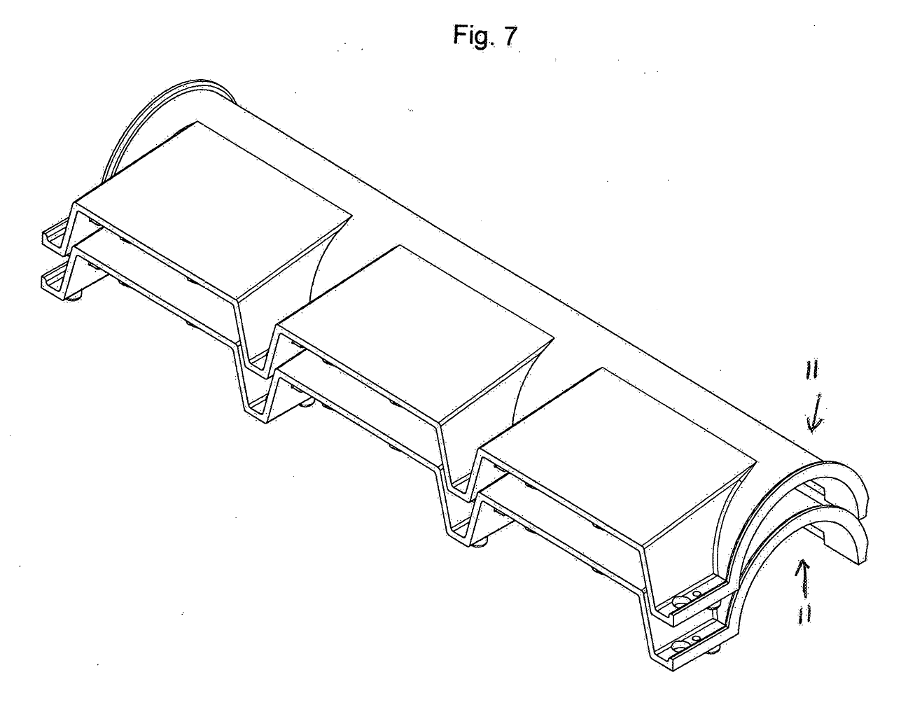

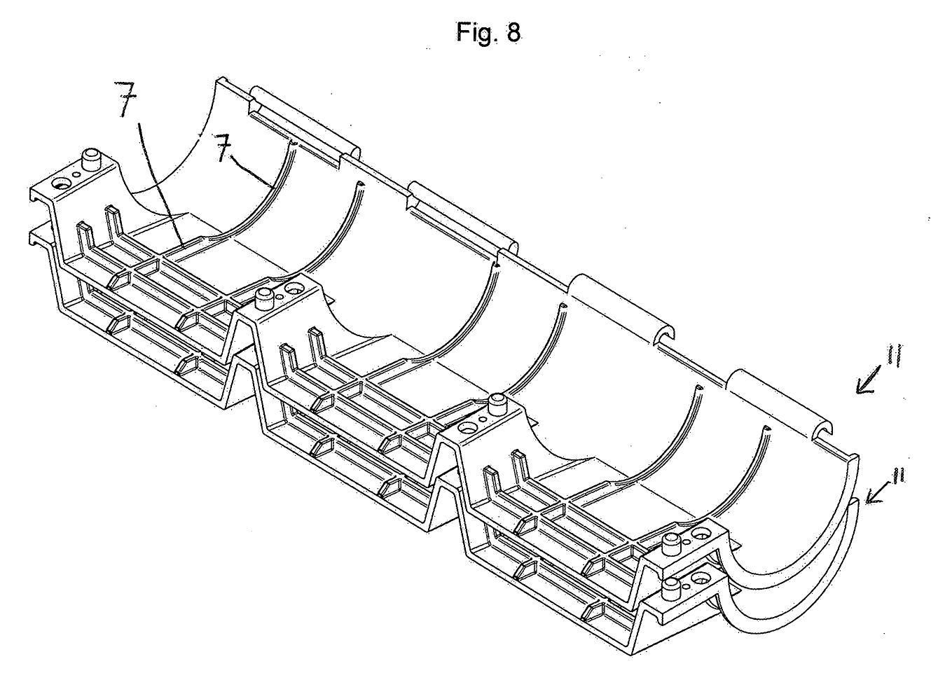

FIG. 8 shows the situation of FIG. 7 in an upside-down orientation.

A number of the reference signs used in FIGS. 1-8 are referring to the abovementioned parts and aspects of the invention, in the following manner.

| | |
|---|---|
| 1 | (twin-fin) fairing |
| C | circumferential direction of the fairing |
| L | longitudinal direction of the fairing |
| 2 | circular-cylindrical object |
| 3A, 3B, 3C | U-shaped portion |
| 4A, 4B, 4C, 4D | O-shaped portion |
| 11 | first fairing-element |
| 12 | second fairing-element |
| 21 | first fin |
| 22 | second fin |
| 31A, 31B, 31C | first subrange |
| 32A, 32B, 32C, 32D | second subrange |
| 41 | first interlocking pin |
| 42 | first interlocking edge |

FIG. 4 shows that the overall-range in the longitudinal direction L of the fairing 1 comprises the three first subranges 31A, 31B, 31C and the four second subranges 32A, 32B, 32C, 32D.

In the three first subranges 31A, 31B, 31C the fairing 1 comprises the three U-shaped portions 3A, 3B, 3C, respectively. The U-shape of the U-shaped portion 3A is clearly seen in FIG. 5. This FIG. 5 shows a cross-section of the fairing 1, taken within the first subrange 31A at the location of a rib 7 of the fairing 1 (the rib 7 is indicated in FIGS. 4, 5 and 8).

FIG. 4 furthermore shows that the first fin 21 of the fairing 1 comprises the shown three first fin portions 21A, 21B, 21C, and that the second fin 22 of the fairing 1 comprises the shown three second fin portions 22A, 22B, 22C. The three first fin portions 21A, 21B, 21C are formed by the three U-shaped portions 3A, 3B, 3C, respectively. Also the three second fin portions 22A, 22B, 22C are formed by the three U-shaped portions 3A, 3B, 3C, respectively.

In the four second subranges 32A, 32B, 32C, 32D the fairing 1 comprises the four O-shaped portions 4A, 4B, 4C, 4D, respectively. The O-shape of the O-shaped portion 4B is clearly seen in FIG. 6. This FIG. 6 shows a cross-section of the fairing 1, taken exactly in the middle of the second subrange 32B.

Furthermore, the fairing 1 comprises in each of the four second subranges 32A, 32B, 32C, 32D each time two attachment strips, protruding from the O-shaped portion concerned, of which each time a first attachment strip 51 is part of the first fairing-element 11, and a second attachment strip 52 is part of the second fairing-element 12 (see FIG. 6). Each of the attachment strips 51, 52 is provided with an interlocking projection 43, an interlocking passageway 44, and a nutted bolt fixation passageway 53 (also see FIG. 1).

From the figures it can be derived that, in the operation condition of the fairing 1 (see FIGS. 4, 5, 6), in each of the four second subranges 32A, 32B, 32C, 32D each time an interlocking projection 43 and an interlocking passageway 44 of the first fairing-element 11 are interlocking with an interlocking passageway 44 and an interlocking projection 43, respectively, of the second fairing-element 11, while then each time a nutted fixation bolt 54 (see FIG. 6) can be extending through the interconnected nutted bolt fixation passageways 53 of the first fairing-element 11 and the second fairing-element 12, in order to firmly attach the first fairing-element 11 and the second fairing-element 12 to one another.

From the figures it can furthermore be derived that, in the operation condition of the fairing 1, two interlocking edges 42 of one of the two fairing-elements 11 and 12 are interlocking with two interlocking pins 41 of the other fairing-element, while at the same time two interlocking edges 42 of said other fairing-element are interlocking with two interlocking pins 41 of said one fairing-element.

Furthermore it is shown in the figures that the fairing 1 at both of its ends in the longitudinal direction L has flanges 5 (indicated in FIG. 4). With these flanges 5, the fairings 1 that are interconnected in the longitudinal direction L can abuttingly support one another, which support as desired can be a slidable support in the circumferential direction C, so that the thus interconnected fairings 1 can reciprocally rotate relative to one another in the circumferential direction C.

Also it is shown in the figures that the fairing 1 can have various ribs, for example the ribs which are parallel to the abovementioned rib 7, which rib 7 is indicated in FIGS. 4 and 8.

As mentioned above, the first fairing-element 11 and the second fairing-element 12 of the twin-fin fairing 1, shown in FIGS. 2-6, are mutually identical. More in particular, as seen in assembled condition (as shown in FIGS. 4-6), the fairing 1 is rotational symmetrical in the sense of a 180 degrees rotation of the complete fairing 1 about a mathematical rotation axis which is perpendicular to the longitudinal direction L of the fairing 1. In the shown example, said mathematical rotation axis is shown in FIG. 1, where it is indicated by the reference sign R. For understanding said rotational symmetry one can imagine that the first fairing-element 11, shown in FIG. 1, is rotated by 180 degrees about said mathematical rotation axis R. This 180 degrees rotation has been indicated in FIG. 1 by means of a curved arrow. Furthermore, one can imagine that the space, which the first fairing-element 11 would occupy directly after the imaginary performing of said 180 degrees rotation, is exactly occupied by a second fairing-element 12. The second fairing-element 12 then interlocks with all its interlocking means 41, 42, 43, 44 with the interlocking means 41, 42, 43, 44 of the first fairing-element 11. In fact, the first fairing-element 11 and the second fairing-element 12 are then forming the fairing 1 shown in FIGS. 4-6.

The shown example illustrates that said rotational symmetry offers sophisticated possibilities for obtaining effective interconnections of the two elements in the circumferential direction C of the fairing. For example, FIGS. 2 and 3 are showing a condition in which each interlocking edge 42 of the fairing 1 each time partly catches around an interlocking pin 41 of the fairing 1, co-operating therewith, while in these FIGS. 2 and 3 the interlocking projections 43 and interlocking passageways 44 of the fairing 1 have not yet been brought in interlocking condition. The lastmentioned interlocking conditions are easily obtainable by farthergoing mutual rotation of the two fairing-elements 11 and 12 around the interlocking pins 41, whereafter the two fairing-elements 11 and 12 can be firmly attached to one another by bringing nutted fixation bolts 54 (see FIG. 6) through the nutted bolt fixation passageways 53. Thus, the mutual fixation of the shown fairing-elements 11 and 12 is not only reliable, but also easy to realize.

It is remarked that the abovementioned examples of embodiments of the invention do not limit the invention, and that various alternatives are possible within the scope of the appended claims.

For example, in the present document U-shapedness is meant to refer to shapes, which substantially have the shape of the character U. Therefore, a U-shape has two free ending “legs”, which at their sides facing away from their free ends are interconnected by the “bottom” of the U-shape concerned. Various kinds of said bottom of the U-shape are possible, not only circular-arched shapes, but also various differently curved shapes, like for instance oval shapes. And also, for example, piecewise-linearly shaped U-shapes are possible and/or U-shapes which are formed by piecewise combinations of curved and linear shapes. Said legs of the U-shape can be mutually parallel, but also non-parallel, for example in that they are, in the direction of their free ends, mutually narrowing (as in the shown example) or mutually widening.

Likewise, in the present document O-shapedness is meant to refer to shapes, which substantially have the shape of the character O. Various kinds of O-shapes are possible, not only circles, but also various other peripheral shapes, like for example oval shapes. And, for example, also piecewise-linearly shaped O-shapes are possible and/or O-shapes which are formed by piecewise combinations of curved and linear shapes.

Furthermore, U-shapes and O-shapes in the sense of the present document can have local interruptions, such as is the case for example in FIGS. 5 and 6, where the fairing 1 nearby the interlocking pins 41 and the interlocking edges 42 has a narrow slit in the first fairing-element 11.

However, other variations or modifications are also possible. These and similar alternatives are deemed to fall within the scope of the invention as defined in the appended claims.

1. Twin-fin fairing for improving fluid flow around a circular-cylindrical object, wherein the fairing has an operation condition in which:
the fairing is installed around said circular-cylindrical object and, under influence of said fluid flow, is reciprocally rotatable relative to the object about the longitudinal direction of the object,
the circumferential direction and the longitudinal direction of the circular-cylindrical object are defining a corresponding circumferential direction of the fairing and a corresponding longitudinal direction of the fairing, respectively, and
the fairing comprises, along at least one subrange of its overall-range in its longitudinal direction, and as seen in perpendicular cross-section relative to its longitudinal direction, at least one U-shaped portion, respectively, which according to the curvature of its U-shape envelopes the object in the circumferential direction of the fairing, and wherein the fairing comprises a first fin and a second fin, which are formed by the at least one U-shaped portion, and which are protruding in a free-ending manner relative to the object, according to the two free-ending legs, respectively, of said U-shape, and which make the fairing rotate according to said reciprocal rotatability under influence of said fluid flow,
characterized in that
the fairing comprises a first fairing-element and a second fairing-element, which are releasable relative to one another, and wherein said operation condition of the fairing requires an assembled condition of the first fairing-element and the second fairing-element, in which assembled condition the first fairing-element and the second fairing-element are mutually connected in the circumferential direction of the fairing, and wherein the first fairing-element and the second fairing-element are comprising the first fin and the second fin, respectively.

2. Twin-fin fairing according to claim 1, wherein, as seen in said operation condition, the fairing comprises along at least one second subrange of its overall-range in its longitudinal direction, and as seen in perpendicular cross-section relative to its longitudinal direction, at least one O-shaped portion, respectively, which according to the curvature of its O-shape envelopes the object in the circumferential direction of the fairing.

3. Twin-fin fairing according to claim 2, wherein the first fin and the second fin are absent in the at least one second subrange.

4. Twin-fin fairing according to claim 1, wherein the first fairing-element and the second fairing-element are mutually identical.

5. Twin-fin fairing according to claim 4, wherein, as seen in said assembled condition, the fairing is rotational symmetrical in the sense of a 180 degrees rotation of the complete fairing about a mathematical rotation axis which is perpendicular to said longitudinal direction of the fairing.

6. Twin-fin fairing according to claim 5, wherein the first fairing-element comprises a first interlocking structure integrally manufactured therewith, which, for forming said assembled condition, can interlock, in a manner determined by said being rotational symmetrical, with a second interlocking structure of the second fairing-element, which second interlocking structure is identical to the first interlocking structure because the second fairing-element is identical to the first fairing-element.

7. Twin-fin fairing according to claim 6, wherein the first interlocking structure comprises at least one first interlocking pin and at least one first interlocking edge, which at least one first interlocking pin and at least one first interlocking edge are identical to at least one second interlocking pin and at least one second interlocking edge of the second interlocking structure, respectively, and wherein, as seen in said assembled condition:
the at least one first interlocking edge catches in a hingeable manner around the at least one second interlocking pin, respectively,
the at least one second interlocking edge catches in a hingeable manner around the at least one first interlocking pin, respectively, and
the at least one first interlocking pin and the at least one second interlocking pin are mutually in-line according to a hinge line, which corresponds to said hingeable manners, which hinge line is parallel to the longitudinal direction of the fairing, and which hinge line is extending in said operation condition at a side of the fairing facing away from the free ends of the first fin and the second fin, and about which hinge line the first fairing-element and the second fairing-element are hingeable relative to one another.

8. Twin-fin fairing according to claim 1 any one of the preceding claims, wherein the first fairing-element is made of plastic and/or wherein the second fairing-element is made of plastic.
